(19) United States
(12) Patent Application Publication
(10) Pub. No.: US 2008/0126450 A1
(43) Pub. Date: May 29, 2008

(54) Aggregation syndication platform

(76) Inventors: Justin O'Neill, Sydney (AU); Keith Marlow, Galston (AU)

Correspondence Address: BRINKS HOFER GILSON & LIONE / YAHOO! OVERTURE, P.O. BOX 10395, CHICAGO, IL, 60610, US

(21) Appl. No.: 11/605,810

(22) Filed: Nov. 28, 2006

(51) Int. Cl. G06F 7/00

(52) U.S. Cl. 707/205; 707/E17.002; 707/E17.018

(57) ABSTRACT

A system and method for processing a plurality of secondary data sets includes the steps of aggregating the secondary data sets to form a primary data set comprising of the secondary data sets, syndicating each of the secondary data sets within the primary data set for standardizing the format of each of the secondary data sets, and geocoding each of the secondary data sets within the primary data set with a geocode, the geocode indicating a geographic location relating to information contained within the secondary data set.

### BACKGROUND

1. Field of the Invention

The present invention generally relates to systems and methods for processing data by a sensor and accessing data from a server.

2. Description of the Known Technology

When a user accesses data from the internet or even a private intranet, the accessed data is generally stored in a variety of different locations and formats. Based upon where the data is stored and what format the data is in, a user accessing the data may be limited to only accessing data based on very limited and very specific searches. Additionally, if the user is seeking data concerning a geographic location, the data may not contain a geographic identifier, better known as a geocode.

For example, if a user wishes to locate apartments in a specific geographic region, the user can easily search for these apartments but will only be provided with apartments having listings that are properly formatted for searchability. Many apartment listings may not be made available to the user. Additionally, if the user wishes to only be informed of apartments within walking distance from public transportation, the user must perform an additional search. Of course, the problem that not all public transportation locations will have location information that is properly formatted for easy searchability is still present. After running two separate searches, the user is challenged with the difficult task of determining which apartments are within walking distance of public transportation.

For another example, assume that the user wishes to search for apartments but also wants to know if there has been any criminal activity near any of the searched apartments. Although it may be easy for the user to search for apartments within the geographic region, determining where criminal activity has occurred from reading a local newspaper's website would be extremely time consuming. Therefore, there is a need for a system and method that are able to standardize data and geocode data for easy searchability.

### SUMMARY

In satisfying the above need, as well as overcoming the enumerated drawbacks and other limitations of the related art, the present invention provides a system and method for processing a plurality of secondary data sets. These secondary data sets include data from a variety of sources including first, second and third party sources. For example, these secondary data sets may include data from any traditional internet or intranet site, but may also include data from a directory service (such as the directory service offered by Yahoo!, Inc. of Sunnyvale, Calif.) as well as from an end users' computer.

The system includes a processor, a storage unit in communication with the processor for storing a primary data set, and a memory unit having a set of processor executable instructions. The processor executable instructions configure the processor to (a) aggregate the secondary data sets to form the primary data set which includes the secondary data sets, (b) syndicate each of the secondary data sets within the primary data set for standardizing the format of each of the secondary data sets, and (c) geocode each of the secondary data sets within the primary data set with a geocode. The geocode indicates a geographic location relating to information contained within the secondary data set.

Additionally, the present invention provides a system and method for accessing a plurality of secondary data sets from a server. The system includes a client having a processor in communication with the server, a storage unit in communication with the server for storing a primary data set, and a memory unit in communication with the processor having a set of processor-executable instructions. The processor-executable instructions configure the processor to identify at least one geographic location of interest, and identify at least one category of interest, and communicate the at least one geographic location of interest and the at least one category of interest to the server. Thereafter, the processor receives from the server the at least one secondary data set having at least one category type relating to the previously communicated at least one category of interest and a geocode relating to the previously communicated at least one geographic location of interest.

Further objects, features and advantages of this invention will become readily apparent to persons skilled in the art after a review of the following description, with reference to the drawings and claims that are appended to and form a part of this specification.

### BRIEF DESCRIPTION OF THE DRAWINGS

FIG. 1 illustrates a system for processing by a server and accessing from the server secondary data sets;

FIG. 2 is a flow chart illustrating a method of processing a plurality of secondary data sets; and

FIG. 3 is a flow chart illustrating a method of accessing secondary data sets.

### DETAILED DESCRIPTION

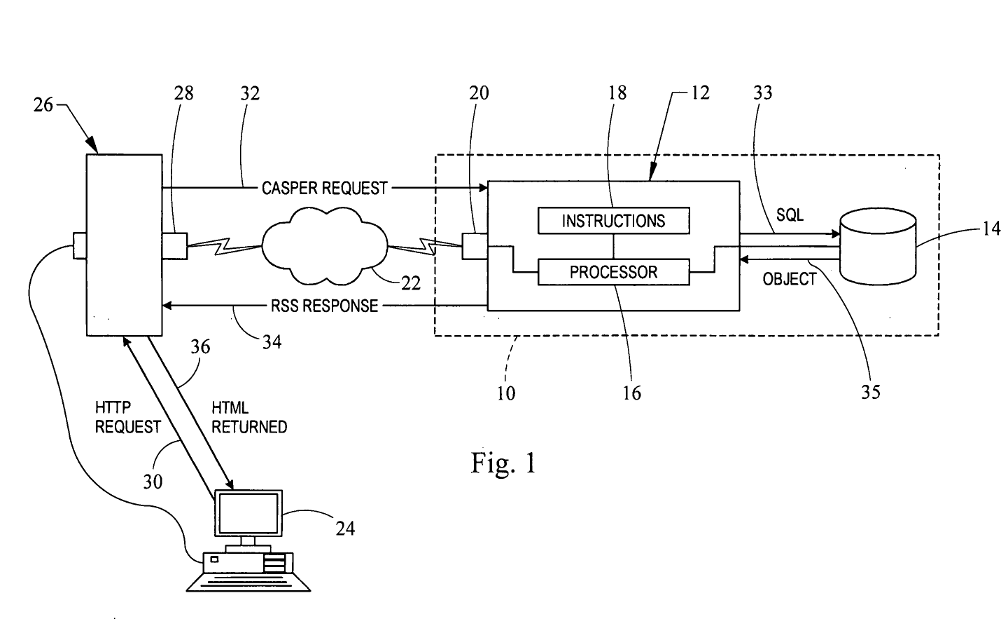

Referring to FIG. 1, a system 10 for aggregating and syndicating data is shown in conjunction with a network 22, a client 24 and a server 26. The system 10 includes a content aggregation/syndication platform (CASPER) server 12 in communication with a storage device 14. It should be understood that the storage device 14 may be integrated within the CASPER server 12 or may be separate from the CASPER server 12 as shown. The storage device 14 may be a magnetic storage device, an optical storage device, a solid state storage device or any storage device suitable for storing electronic information.

The CASPER server 12 includes a processor 16 in communication with the storage device 14 and a memory unit 18. As will be described later in this detailed description, the memory unit 18 contains a set of instructions for configuring the processor to aggregate, syndicate, geocode and, optionally, categorize and/or de-duplicate data.

Also in communication with the processor 16 is a network interface 20. The network interface 20 enables the system 10 to communicate with a network 22. The network 22 may be the internet or may be a private intranet, or any combination of public and private networks.

The system 10 is generally accessed via a client 24 connected to a web server 26. The client 24 may be a general purpose computer or may be a dedicated device capable of accessing electronic data. The web server 26 has a network interface 28 that is connected to the network 22. For example, the client 24 may send an HTTP request (indicated in the drawing figure by arrow 30) to the web server 26. The web server 26 then sends a CASPER request (arrow 32) to the CASPER server 12. The CASPER server 12 then sends a Structured Query Language (SQL) request (arrow 33) to the storage device 14. In response, the storage device 14 responds with an object (arrow 35). The CASPER server 12 of the system 10 then sends a RSS response (arrow 34) to the web server 26. Finally, the web server 26 sends an HTML returned signal (arrow 36) to the client 24. Alternatively, the client 24 may be using a web browser running its own embedded RSS client. If this is the case, the CASPER server 24 could generate a geoRSS which is provided directly to the browser running on the client 24 for direct usage.

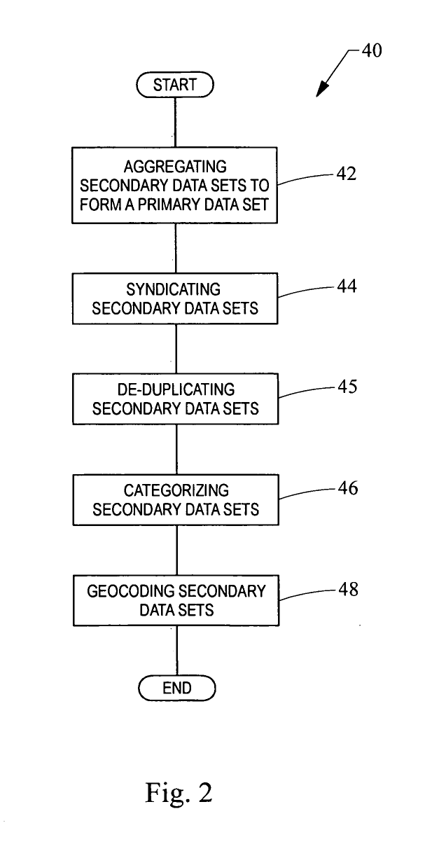

Referring to FIGS. 1 and 2, a method 40 for aggregating, syndicating, geocoding and optionally categorizing and/or de-duplicating data is shown. The method 40 may be implemented as a set of processor-executable instructions that are stored in the memory unit 18 for execution by the processor 16 of the system 10. Of course, it should be understood that the method 40 may be stored on any computer readable medium.

In step 42, secondary data sets are aggregated to form a primary data set comprising of a plurality of secondary data sets. These secondary data sets may include data from first party, second party or third party source. For example, the secondary data sets may include data from an already categorized first party source, such as a directory service offered by Yahoo!, Incorporated of Sunnyvale, Calif. Additionally, the secondary data sets may be from a third party source such as any of those found on the internet. Finally, the secondary data sets may be from a second party source such as data stored on the client 24. Data stored on the client 24 may include email information, calendaring information, or any other data stored on the client 24.

As shown in step 44, once the secondary data sets are aggregated to form a primary data set, the secondary data sets are then syndicated. The step of aggregating compiles the secondary data sets to form the primary data sets. The step of syndicating formats the secondary data sets within the primary data set in a standardized format allowing searchability and accessibility, while minimizing the number of processor cycles required to access and search the secondary data sets.

Optionally, in step 45, the secondary data sets within the primary data set may be de-duplicated. De-duplication removes any unnecessary duplicate data sets to minimize the number of secondary data sets. By so doing, the amount of storage required from the storage unit 14 is minimized. Optionally, in step 46, the secondary data sets within the primary data set can then be categorized in a variety of categories. These categories may be hierarchical in nature. For example, these categories may be best viewed as an acyclic directed graph, where the vertexes are category terms and the edges indicate a ‘contains’ relationship, with some ‘root’ vertex indicating the start point from which the categorizations begin. These categories may also include pre defined categories such as business listings, events, tourist attractions, weather, news, sports, movies, dating personals, automobiles, shopping and real estate. Of course, additional categories may be considered.

In step 48, the secondary data sets within the primary data set are then geocoded. A geocode is a code identifying the geographic location concerning information within the secondary data set. For example, assume that a secondary data set to be geocoded contains information regarding an event at a specific address. A geocode would be added to the secondary data set, thereby providing a latitudinal and longitudinal location of the event. The geocode may also include an altitude value, helpful in indicating which altitude the event relates to. For example, the altitude value may indicate which floor of a building the event is related to.

By executing the above method 40, data from multiple sources can be aggregated, syndicated (gathered and placed in a uniform format), de-duplicated, categorized and geocoded. The execution of the method 4 allows the client 24 to easily search and access the relevant secondary data sets.

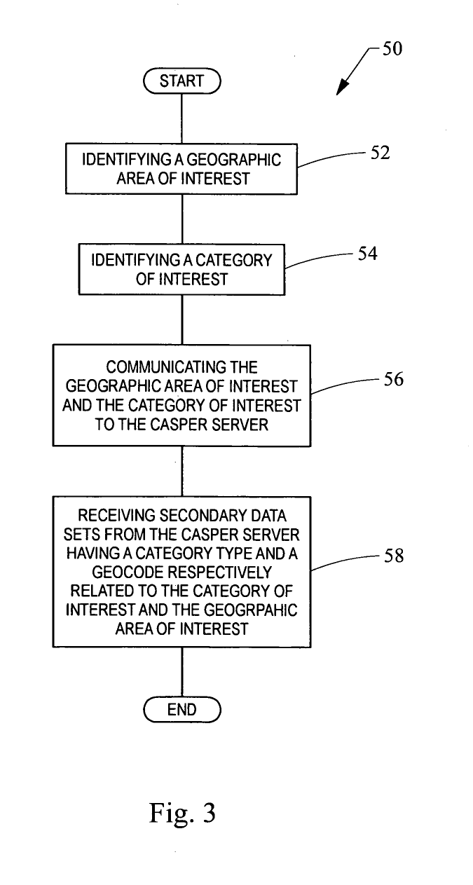

Referring to FIGS. 1 and 3, a method 50 for accessing the secondary data sets from the system 10 is shown. The method 50 is generally a processor-executable method that can be stored on any computer readable medium. The steps of method 50 may be performed in any suitable manner. For example, a user operating the client 24 may enter information in a web page or other user interface. Upon actuation, the web page is sent by the client 24 to the server 26 for further processing.

In step 52, the user of the client 24 identifies a geographic area of interest. This geographic area of interest may be a specific address or may be a latitudinal and longitudinal coordinate, or may be any other suitable position-identifying information or data. Next, as shown in step 54, the user of the client 24 identifies a category of interest. This category of interest may include business listings, events, tourist attractions, weather, news, sports, movies, dating personals, automobiles, shopping and real estate. However, it should be understood that additional categories may be identified.

In step 56, the client 24 communicates to the processor 16 of the CASPER server 12. The information communicated includes the geographic area of interest and a category of interest. This can be accomplished by sending an HTTP request from the client 24 (arrow 30) to the web server 26. Thereafter, the web server sends a CASPER request to the system 10 (arrow 32).

In step 58, the client 24 receives secondary data sets from the CASPER server 12 having a category type and a geocode related to the category of interest and the geographic area of interest, respectively. For example, in response to receiving an HTTP request from the client 24, the CASPER server 12 accesses the relevant secondary data sets stored on the storage device 14 by sending a SQL request (arrow 33) to the storage device 14 and receiving an object (arrow 35) from the storage device 14. It should be understood that this is just one way to access the storage device 14 and that any suitable method for accessing the storage device 14 may by utilized.

Thereafter, the CASPER server 12 sends a real simple syndication (RSS) response (arrow 34) to the web server 26. Thereafter, the web server 26 sends an HTML returned signal (arrow 36) to the client 24. The HTML returned signal (arrow 36) contains the secondary data sets having a category type and a geocode related to the category of interest and a geographic area of interest, respectively.

In order to better illustrate method 50, the following example is presented. Assume that the user of the client 24 is a graduate student at the University of Michigan in Ann Arbor, Mich. The user of the client 24 desires (1) an apartment (2) within the city of Ann Arbor, (3) within walking distance of public transportation and (4) located where few criminal events occur. The user of the client 24 identifies the geographic area of interest (Ann Arbor, Mich. and within walking distance of public transportation) and categories of interest (apartments and criminal events). The geographic areas of interest and the categories of interest are then sent to the system 10. Because the system 10 has already aggregated, syndicated, categorized and geocoded secondary data sets from a variety of different sources, the system 10 is able to quickly search and access relevant secondary data sets. The system 10 then communicates the relevant secondary data sets to the client 24. The relevant secondary data sets would include secondary data sets of apartments located within Ann Arbor, Mich. and within walking distance of public transportation while also providing information regarding to any criminal events within those geographic areas of interest.

As a person skilled in the art will readily appreciate, the above description is meant as an illustration of implementation of the principles this invention. This description is not intended to limit the scope or application of this invention in that the invention is susceptible to modification, variation and change, without departing from the spirit of this invention, as defined in the following claims.

1. A method for processing a plurality of secondary data sets, the method comprising the steps of:
aggregating the secondary data sets to form a primary data set comprising of the secondary data sets;
syndicating each of the secondary data sets within the primary data set for standardizing the format of each of the secondary data sets; and
geocoding each of the secondary data sets within the primary data set with a geocode, the geocode indicating a geographic location relating to information contained within the secondary data set.

2. The method of claim 1, wherein the secondary data sets comprise information originating from at least one of a first party source, a second party source and a third party source.

3. The method of claim 1, further comprising the step of categorizing each of the secondary data sets with at least one category type.

4. The method of claim 3, wherein the at least one category type is arranged as a hierarchy.

5. The method of claim 4, wherein the hierarchy is an acyclic directed graph, wherein the acyclic directed graph includes vertexes having category terms and edges indicating a relationship.

6. The method of claim 1, further comprising the step of de-duplicating the secondary data sets within the primary data set for removing duplicate secondary data sets.

7. The method of claim 1, wherein the geocode comprises a latitudinal coordinate and a longitudinal coordinate.

8. The method of claim 7, wherein the geocode further comprises an altitude value.

9. A method of accessing from a server a plurality of secondary data sets, the method comprising the steps of:
identifying at least one geographic location of interest;
identifying at least one category of interest;
communicating the at least one geographic location of interest and the at least one category of interest to the server, the server having a storage unit storing a primary data set comprising the plurality of secondary data sets,
each of the secondary data sets having a uniform format, at least one category type and a geocode, the geocode indicating a geographic location relating to information contained within the secondary data set; and
receiving from the server the at least one secondary data set having at least one category type relating to the previously communicated at least one category of interest and a geocode relating to the previously communicated at least one geographic location of interest.

10. The method of claim 9, wherein the secondary data sets comprise information originating from at least one of a first party source, a second party source and a third party source.

11. The method of claim 9, wherein the at least one category type is arranged as a hierarchy.

12. The method of claim 11, wherein the hierarchy is an acyclic directed graph, wherein the acyclic directed graph includes vertexes having category terms and edges indicating a relationship.

13. The method of claim 9, wherein the geocode comprises a latitudinal coordinate and a longitudinal coordinate.

14. The method of claim 13, wherein the geocode further comprise an altitude value.

15. A system for processing a plurality of secondary data sets, the system comprising:
a processor;
a storage unit in communication with the processor to store a primary data set;
a memory unit having a set of processor executable instructions, the processor executable instructions configuring the processor to:
aggregate the secondary data sets to form the primary data set comprising of the secondary data sets;
syndicate each of the secondary data sets within the primary data set for standardizing the format of each of the secondary data sets; and
geocode each of the secondary data sets within the primary data set with a geocode, the geocode indicating a geographic location relating to information contained within the secondary data set.

16. The system of claim 15, wherein the secondary data sets comprise information originating from at least one of a first party source, a second party source and a third party source.

17. The system of claim 15, further comprising the step of categorizing each of the secondary data sets with at least one category type.

18. The system of claim 17, wherein the at least one category type is arranged as a hierarchy.

19. The system of claim 18, wherein the hierarchy is an acyclic directed graph, wherein the acyclic directed graph includes vertexes having category terms and edges indicating a relationship.

20. The system of claim 15, wherein the processor executable instructions further configure the processor to de-duplicate the secondary data sets within the primary data set for removing duplicate secondary data sets.

21. The system of claim 15, wherein the geocode comprises a latitudinal coordinate and a longitudinal coordinate.

22. The system of claim 21, wherein the geocode further comprise an altitude value.

23. A system for accessing from a server a plurality of secondary data sets, the system comprising:
a client having a processor in communication with the server;
a storage unit in communication with the server for storing a primary data set;
a memory unit in communication with the processor, the memory unit having a set of processor executable instructions, the processor executable instructions configuring the processor to:
identify at least one geographic location of interest;
identify at least one category of interest;
communicate the at least one geographic location of interest and the at least one category of interest to the server;
each of the secondary data sets having a uniform format, at least one category type and a geocode, the geocode indicating a geographic location relating to information contained within the secondary data set; and
receive from the server the at least one secondary data set having at least one category type relating to the previously communicated at least one category of interest and a geocode relating to the previously communicated at least one geographic location of interest.

24. The system of claim 23, wherein the secondary data sets comprise information originating from at least one of a first party source, a second party source and a third party source.

25. The system of claim 23, wherein the at least one category type is arranged as a hierarchy.

26. The system of claim 25, wherein the hierarchy is an acyclic directed graph, wherein the acyclic directed graph includes vertexes having category terms and edges indicating a relationship.

27. The system of claim 23, wherein the geocode comprises a latitudinal coordinate and a longitudinal coordinate.

28. The system of claim 27, wherein the geocode further comprise an altitude value.

29. In a computer readable storage medium having stored therein instructions executable by a programmed processor for processing a plurality of secondary data sets, the storage medium comprising instructions for:
aggregating the secondary data sets to form a primary data set comprising of the secondary data sets;
syndicating each of the secondary data sets within the primary data set for standardizing the format of each of the secondary data sets; and
geocoding each of the secondary data sets within the primary data set with a geocode, the geocode indicating a geographic location relating to information contained within the secondary data set.

30. The instructions of claim 29, wherein the secondary data sets comprise information originating from at least one of a first party source, a second party source and a third party source.

31. The instructions of claim 29, further comprising the step of categorizing each of the secondary data sets with at least one category type.

32. The instructions of claim 31, wherein the at least one category type is arranged as a hierarchy.

33. The instructions of claim 32, wherein the hierarchy is an acyclic directed graph, wherein the acyclic directed graph includes vertexes having category terms and edges indicating a relationship.

34. The instructions of claim 29, further comprising the step of de-duplicating the secondary data sets within the primary data set for removing duplicate secondary data sets.

35. The instructions of claim 29, wherein the geocode comprises a latitudinal coordinate and a longitudinal coordinate.

36. The instructions of claim 35, wherein the geocode further comprise an altitude value.

37. In a computer readable storage medium having stored therein instructions executable by a programmed processor for accessing from a server a plurality of secondary data sets, the storage medium comprising instructions for:
identifying at least one geographic location of interest;
identifying at least one category of interest;
communicating the at least one geographic location of interest and the at least one category of interest to the server, the server having a storage unit storing a primary data set comprising the plurality of secondary data sets,
each of the secondary data sets having a uniform format, at least one category type and a geocode, the geocode indicating a geographic location relating to information contained within the secondary data set; and
receiving from the server the at least one secondary data set having at least one category type relating to the previously communicated at least one category of interest and a geocode relating to the previously communicated at least one geographic location of interest.

38. The instructions of claim 37, wherein the secondary data sets comprise information originating from at least one of a first party source, a second party source and a third party source.

39. The instructions of claim 37, wherein the at least one category type is arranged as a hierarchy.

40. The instructions of claim 39, wherein the hierarchy is an acyclic directed graph, wherein the acyclic directed graph includes vertexes having category terms and edges indicating a relationship.

41. The instructions of claim 37, wherein the geocode comprises a latitudinal coordinate and a longitudinal coordinate.

42. The instructions of claim 41, wherein the geocode further comprise an altitude value.
